(19) United States
(12) Patent Application Publication
(10) Pub. No.: US 2011/0281562 A1
(43) Pub. Date: Nov. 17, 2011

(54) PROVIDING CUSTOMIZED IN-VEHICLE SERVICES USING A VEHICLE TELEMATICS UNIT

(75) Inventor: Matt C. Videtich, Farmington Hills, MI (US)

(73) Assignee: GENERAL MOTORS LLC, Detroit, MI (US)

(21) Appl. No.: 12/780,383

(22) Filed: May 14, 2010

(51) Int. Cl. H04W 4/00; G06F 17/30; G06F 15/16

(52) U.S. Cl. 455/414.1; 709/224; 707/609; 707/E17.005

(57) ABSTRACT

A method and system for providing a customized in-vehicle service to one or more people inside a vehicle via a vehicle telematics unit. The method involves detecting the presence of a personal mobile device at the vehicle, associating the detected mobile device with a specific person, and providing a customized service to the specific person identified via the vehicle telematics unit. The method and system can be used, for example, to adjust vehicle settings or operation in response to detecting the presence of a specific person's cell phone or other mobile device.

### TECHNICAL FIELD

The present invention generally relates to vehicle telematics systems and, more particularly, to techniques for identifying one or more people inside a vehicle via a vehicle telematics unit.

### BACKGROUND

Vehicles are increasingly designed not only to transport an occupant to a destination but also to provide an enjoyable experience at the same time. For instance, a driver may adjust the vehicle seat, listen to a certain radio station, set the vehicle cabin temperature to a preferred temperature, etc. Customizing or setting a vehicle preference is increasingly becoming a part of using a vehicle.

### SUMMARY OF THE INVENTION

According to one embodiment, there is presented a method of identifying one or more people inside a vehicle via a vehicle telematics unit, comprising the steps of (a) detecting the presence of a personal mobile device at the vehicle; (b) associating the detected mobile device with a specific person; and (c) providing a customized service to the specific person identified via the vehicle telematics unit.

In another embodiment, there is presented a method of identifying one or more people inside a vehicle via a vehicle telematics unit, comprising the steps of (a) receiving a Bluetooth address associated with a personal mobile device; (b) establishing a service preference based on a telematics service subscriber request entered via a service web application or the vehicle telematics unit; (c) associating the service preference with the Bluetooth address; (d) detecting the presence of the personal mobile device at the vehicle through a wireless connection between the mobile device and the vehicle; (e) associating the detected mobile device with the service preference; and (f) providing a customized service to one or more occupants in the vehicle using the service preference.

### BRIEF DESCRIPTION OF THE DRAWINGS

Preferred exemplary embodiments of the invention will hereinafter be described in conjunction with the appended drawings, wherein like designations denote like elements, and wherein:

FIG. 1 is a block diagram depicting an exemplary embodiment of a communications system that is capable of utilizing the method disclosed herein;

FIG. 2 is a flowchart of an exemplary method that provides configuration steps that may be used to identify one or more people inside a vehicle via a vehicle telematics unit; and

FIG. 3 is a flowchart depicting an embodiment of a method of identifying one or more people inside a vehicle via a telematics unit and may be used with the exemplary method in FIG. 2.

### DETAILED DESCRIPTION OF THE PREFERRED EMBODIMENTS

The system and methods described below are directed to different embodiments for identifying one or more people inside a vehicle via a vehicle telematics unit. This can be helpful, for example, in case of an emergency where the presence of one or more personal mobile devices associated with one or more occupants in the vehicle are communicated to emergency personnel. In another instance, the vehicle speed can be limited if one or more personal mobile devices associated with one or more young occupants are present in the vehicle. In general, the disclosed methods detect the presence of a personal mobile device in the vehicle, associate the detected mobile device with a specific person; and provide a customized service to the specific person identified via the vehicle telematics unit.

### Communications System—

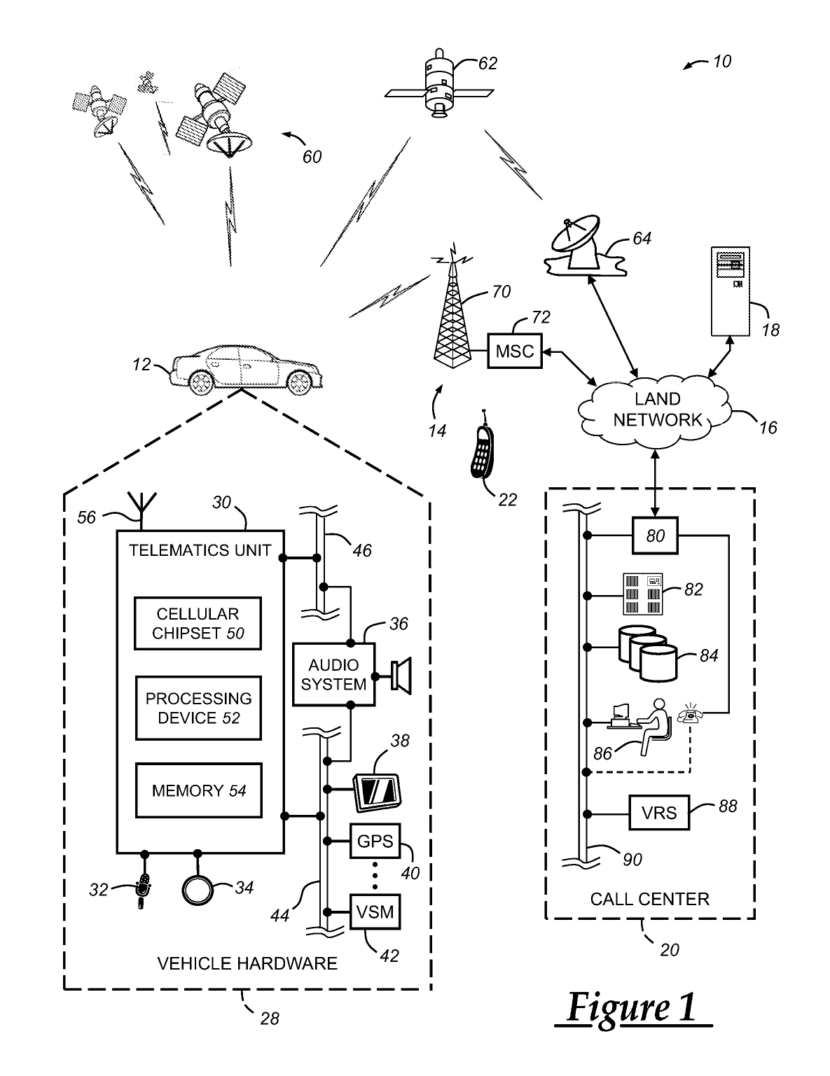

With reference to FIG. 1, there is shown an exemplary operating environment that comprises a mobile vehicle communications system 10 and that can be used to implement the method disclosed herein. Communications system 10 generally includes a vehicle 12, one or more wireless carrier systems 14, a land communications network 16, a computer 18, and a call center 20. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such exemplary system 10; however, other systems not shown here could employ the disclosed method as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 28 is shown generally in FIG. 1 and includes a telematics unit 30, a microphone 32, one or more pushbuttons or other control inputs 34, an audio system 36, a visual display 38, and a GPS module 40 as well as a number of vehicle system modules (VSMs) 42. Some of these devices can be connected directly to the telematics unit such as, for example, the microphone 32 and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 is an OEM-installed device that enables wireless voice and/or data communication over wireless carrier system 14 and via wireless networking so that the vehicle can communicate with call center 20, other telematics-enabled vehicles, or some other entity or device. The telematics unit preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live adviser or voice response unit at the call center 20) and data communication (e.g., to provide GPS location data or vehicle diagnostic data to the call center 20), the system can utilize a single call over a voice channel and switch as needed between voice and data transmission over the voice channel, and this can be done using techniques known to those skilled in the art.

According to one embodiment, telematics unit 30 utilizes cellular communication according to either GSM or CDMA standards and thus includes a standard cellular chipset 50 for voice communications like hands-free calling, a wireless modem for data transmission, an electronic processing device 52, one or more digital memory devices 54, and a dual antenna 56. It should be appreciated that the modem can either be implemented through software that is stored in the telematics unit and is executed by processor 52, or it can be a separate hardware component located internal or external to telematics unit 30. The modem can operate using any number of different standards or protocols such as EVDO, CDMA, GPRS, and EDGE. Wireless networking between the vehicle and other networked devices can also be carried out using telematics unit 30. For this purpose, telematics unit 30 can be configured to communicate wirelessly according to one or more wireless protocols, such as any of the IEEE 802.11 protocols, WiMAX, or Bluetooth. When used for packet-switched data communication such as TCP/IP, the telematics unit can be configured with a static IP address or can set up to automatically receive an assigned IP address from another device on the network such as a router or from a network address server.

Processor 52 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 52 executes various types of digitally-stored instructions, such as software or firmware programs stored in memory 54, which enable the telematics unit to provide a wide variety of services. For instance, processor 52 can execute programs or process data to carry out at least a part of the method discussed herein.

Telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

GPS module 40 receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to call center 20 or other remote computer system, such as computer 18, for other purposes, such as fleet management. Also, new or updated map data can be downloaded to the GPS module 40 from the call center 20 via the telematics unit 30.

Apart from the audio system 36 and GPS module 40, the vehicle 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests. As examples, one VSM 42 can be an engine control module (ECM) that controls various aspects of engine operation such as fuel ignition and ignition timing, another VSM 42 can be a powertrain control module that regulates operation of one or more components of the vehicle powertrain, and another VSM 42 can be a body control module that governs various electrical components located throughout the vehicle, like the vehicle's power door locks and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicle 12, as numerous others are also possible.

Vehicle electronics 28 also includes a number of vehicle user interfaces that provide vehicle occupants with a means of providing and/or receiving information, including microphone 32, pushbuttons(s) 34, audio system 36, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art. The pushbutton(s) 34 allow manual user input into the telematics unit 30 to initiate wireless telephone calls and provide other data, response, or control input. Separate pushbuttons can be used for initiating emergency calls versus regular service assistance calls to the call center 20. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM and satellite radio, CD, DVD and other multimedia functionality. This functionality can be provided in conjunction with or independent of the infotainment module described above. Visual display 38 is preferably a graphics display, such as a touch screen on the instrument panel or a heads-up display reflected off of the windshield, and can be used to provide a multitude of input and output functions. Various other vehicle user interfaces can also be utilized, as the interfaces of FIG. 1 are only an example of one particular implementation.

Wireless carrier system 14 is preferably a cellular telephone system that includes a plurality of cell towers 70 (only one shown), one or more mobile switching centers (MSCs) 72, as well as any other networking components required to connect wireless carrier system 14 with land network 16. Each cell tower 70 includes sending and receiving antennas and a base station, with the base stations from different cell towers being connected to the MSC 72 either directly or via intermediary equipment such as a base station controller. Cellular system 14 can implement any suitable communications technology, including for example, analog technologies such as AMPS, or the newer digital technologies such as CDMA (e.g., CDMA2000) or GSM/GPRS. As will be appreciated by those skilled in the art, various cell tower/base station/MSC arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 14, a different wireless carrier system in the form of satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

Land network 16 may be a conventional land-based telecommunications network that is connected to one or more landline telephones and connects wireless carrier system 14 to call center 20. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, call center 20 need not be connected via land network 16, but could include wireless telephony equipment so that it can communicate directly with a wireless network, such as wireless carrier system 14.

Computer 18 can be one of a number of computers accessible via a private or public network such as the Internet. Each such computer 18 can be used for one or more purposes, such as a web server accessible by the vehicle via telematics unit 30 and wireless carrier 14. Other such accessible computers 18 can be, for example: a service center computer where diagnostic information and other vehicle data can be uploaded from the vehicle via the telematics unit 30; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or call center 20, or both. A computer 18 can also be used for providing Internet connectivity such as DNS services or as a network address server that uses DHCP or other suitable protocol to assign an IP address to the vehicle 12.

Where the computer 18 is used by a subscriber or other user to access telematics services, it can be implemented using any suitable type of computer (e.g., a desktop computer or portable computer). In this regard, computer 18 is used as a processing device located remotely of the vehicle, even though as a portable computer it may occasionally be located at the vehicle.

Apart from computer 18, other types of remotely located processing devices can be used. For example, a mobile device 22 can be used and can be one of a number of such communication devices used by subscribers. Each mobile device 22 is a processing device that can be used for one or more purposes, such as voice communication, text messaging, email, web browsing, gaming, camera, video recording, sending and receiving photos and videos, audio player (e.g., MP3), radio, GPS navigation, personal organizer, to name but a few. In the illustrated embodiment, mobile device 22 is a mobile phone also known as a cell or cellular phone that connects to a cellular network such as system 14. In another embodiment, mobile device 22 can be a personal digital assistant (PDA) that may or may not provide telephony services. Mobile device 22 can employ one of a variety of wireless technology including Bluetooth (e.g. hands-free headset, games, watches, sports sensors, medical devices, etc.), etc. Various other types of suitable processing devices will be apparent to those skilled in the art.

Call center 20 is designed to provide the vehicle electronics 28 with a number of different system back-end functions and, according to the exemplary embodiment shown here, generally includes one or more switches 80, servers 82, databases 84, live advisers 86, as well as an automated voice response system (VRS) 88, all of which are known in the art. These various call center components are preferably coupled to one another via a wired or wireless local area network 90. Switch 80, which can be a private branch exchange (PBX) switch, routes incoming signals so that voice transmissions are usually sent to either the live adviser 86 by regular phone or to the automated voice response system 88 using VoIP. The live adviser phone can also use VoIP as indicated by the broken line in FIG. 1. VoIP and other data communication through the switch 80 is implemented via a modem (not shown) connected between the switch 80 and network 90. Data transmissions are passed via the modem to server 82 and/or database 84. Database 84 can store account information such as subscriber authentication information, vehicle identifiers, profile records, behavioral patterns, and other pertinent subscriber information. Data transmissions may also be conducted by wireless systems, such as 802.11x, GPRS, and the like. Although the illustrated embodiment has been described as it would be used in conjunction with a manned call center 20 using live adviser 86, it will be appreciated that the call center can instead utilize VRS 88 as an automated adviser or, a combination of VRS 88 and the live adviser 86 can be used.

### Method—

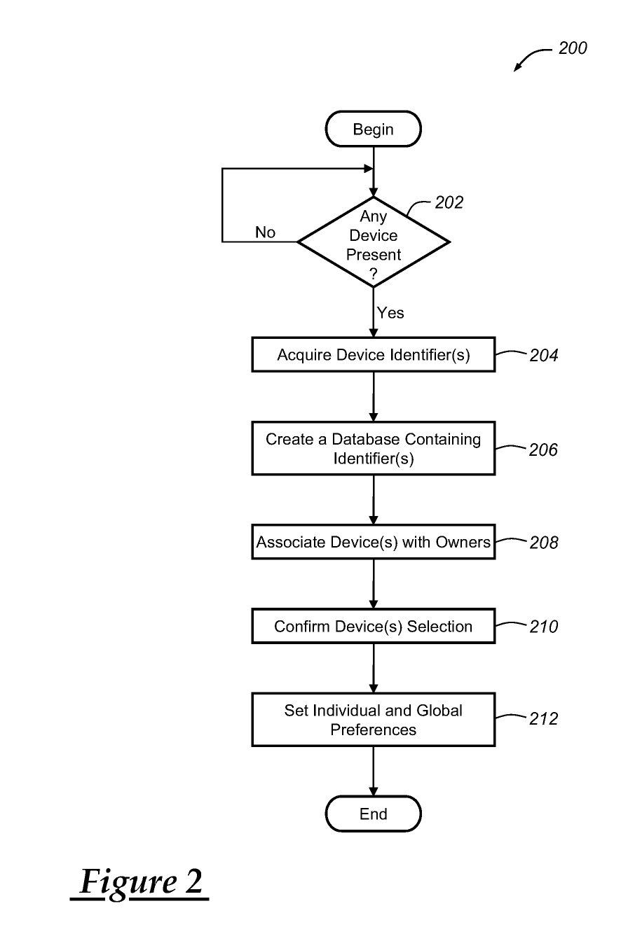

Turning now to FIG. 2, there is shown a method 200 for providing configuration steps that may be used to identify one or more people inside a vehicle via a telematics unit. The method starts at step 202 and begins by checking if there is any device present. The purpose of this step is to identify one or more mobile devices that can be associated with one or more occupants inside the vehicle. There are several options to identify a mobile device including automatic identification (e.g., vehicle automatically identifies a mobile device without subscriber intervention), identification with subscriber intervention, etc. Here, a subscriber is a person or entity who either has legal title to the vehicle (e.g., a purchaser, corporation, parent) or has possession of the vehicle for regular use (e.g., a lessee, employee driving a company car, licensed minor), or both (e.g., a purchaser driver), and who has opted to receive vehicle information from a telematics service. In one embodiment, vehicle 12 telematics unit 30 detects a radio signal from personal mobile device 22 by sending an inquiry to find any device to connect to and receiving a response to such an inquiry. Telematics unit 30 may continuously monitor for one or more devices, send a monitoring signal at predetermined time intervals, or monitor until a specific number of devices is reached (e.g., number is limited by subscriber through an earlier communication with call center 20). In another embodiment, a vehicle telematics service subscriber provides a list of one or more mobile devices via one of a variety of methods including entering a list via a telematics service subscription website, communicating a list to call center 20 via telematics unit 30 or others (e.g., phone call, text message, email, etc.), etc. Once one or more devices are detected, method 200 proceeds to the next step. However, in case no device is identified then method 200 stays at this step to keep checking if there is any device present.

At step 204, the method acquires a device identifier. In one embodiment, a software application running in telematics unit 30 inquires about one or more identifiers of device 22. The list of identifiers includes device name which can be customized by a user (e.g., Matt's phone, Dad's PDA, Mom's iPhone, etc.) or default (e.g., manufacturer and model), identification number (e.g., Bluetooth 48 bit address, phone number), device type which can be classified into a class (e.g., major type such as phone, peripheral, etc.) and one or more subclasses (e.g., minor type such as smart), description, etc. During this step, method 200 does not necessarily acquire several identifiers for a device; however, it may acquire enough identifiers to differentiate between devices. For example, in one embodiment, it may only acquire device 22 identification number such as Bluetooth address which is unique for each device. In another case, it may acquire as many identifiers per device as possible. For example, in one embodiment, it may acquire device 22 identification number (e.g., phone number), device type (e.g., phone), description (e.g., Dad's phone), and/or default description (e.g., manufacturer and model), etc.

Next, at step 206, method 200 creates a database containing one or more identifiers acquired previously. Method 200 can build up a database that can be used to more quickly and effectively identify one or more occupants inside vehicle 12 in the future. The database employed can be of any type suitable including operational, in-memory, real-time, relational, navigational, end-user, distributed, and/or other databases. In one embodiment, the database may be stored in memory device 54 of telematics unit 30. In another embodiment, the database may be stored in database 84 of call center 20. In any case, the database can be updated in a variety of way including predetermined time interval (e.g., once a year, month, week, etc. by call center or subscriber), on demand (e.g., request by subscriber, new device is present, etc.). It should be appreciated that other techniques and methods may be used to determine how and where to store the information.

At step 208, method 200 proceeds to associate one or more devices with owners. An example of possible associations include associating two or more acquired identifiers (e.g., Dad's PDA and Bluetooth address, Mom's iphone and phone number, Little Johnny's toy and Bluetooth address, Grand Pa's heart monitor and WiFi MAC address, etc.). There are several techniques that can be employed to associate one or more devices with their corresponding owners. In one embodiment, one or more device identifiers and their corresponding owners data is retrieved from database 84 and processed in call center 20 or elsewhere to associate the devices with corresponding owners. In another embodiment, one or more device identifiers and their corresponding owners data is retrieved from memory 54 and the association is processed by processing device 52. This association can be stored in memory 54, database 84, or elsewhere as previously described in step 206.

Next, at step 210, method 200 confirms one or more devices selection. In one embodiment, live adviser 86 or VRS 88 from call center 20 contacts the vehicle subscriber via a phone call placed through telematics unit 30 to confirm one or more devices selection. However, other communication techniques including visual, voice, and/or other communications can be used, for example, vehicle subscriber can be contacted via email, text message, mail, and/or other suitable communication methods to confirm one or more devices selection.

At step 212, method 200 sets individual and global preferences. The subscriber may elect to set individual preferences for each individual if only devices associated with one occupant are detected. Therefore, an occupant (e.g., driver) preferences are executed later if only devices associated with that occupant are detected. In addition, the subscriber may set global preferences if one or more detected mobile devices in the vehicle are associated with more than one occupant. The preferences can be set according to a priority list depending on the occupant present (e.g., subscriber only, adults only, adult and youth, youth only, etc.). For example, in one embodiment, the preferences can include restricting strong language radio programs if one or more mobile devices associated with one or more young occupants are in the vehicle (e.g., dad and son, mom and daughter, etc.). In another embodiment, the preferences can include limiting the speed of the vehicle if one or more personal mobile devices associated with only one or more young occupants are present in the vehicle (e.g., son only, daughter only, son and daughter, son and friends, etc.). In a third embodiment, the preferences can include informing emergency personnel via telematics unit 30 of the presence of one or more personal mobile devices associated with one or more occupants inside the vehicle in case of an emergency. Other preferences that can be set include setting favorite radio or infotainment station (e.g., news station, music station, cartoon channel, etc.), seat position, climate setting (e.g., temperature), mirrors, etc. Skilled artisans will appreciate that other preferences can be set.

Method 200 is not limited to the embodiment disclosed herein as others are also possible. For example, in one embodiment one or some of the steps 202-212 can be handled by a single or multiple communication sessions between the subscriber and a call center adviser 86 including a phone call, text message, email, etc. In another embodiment, the one or some of the steps 202-212 can be entered via a subscriber service website (e.g., onstar.com). Other embodiments will become apparent to skilled artisans.

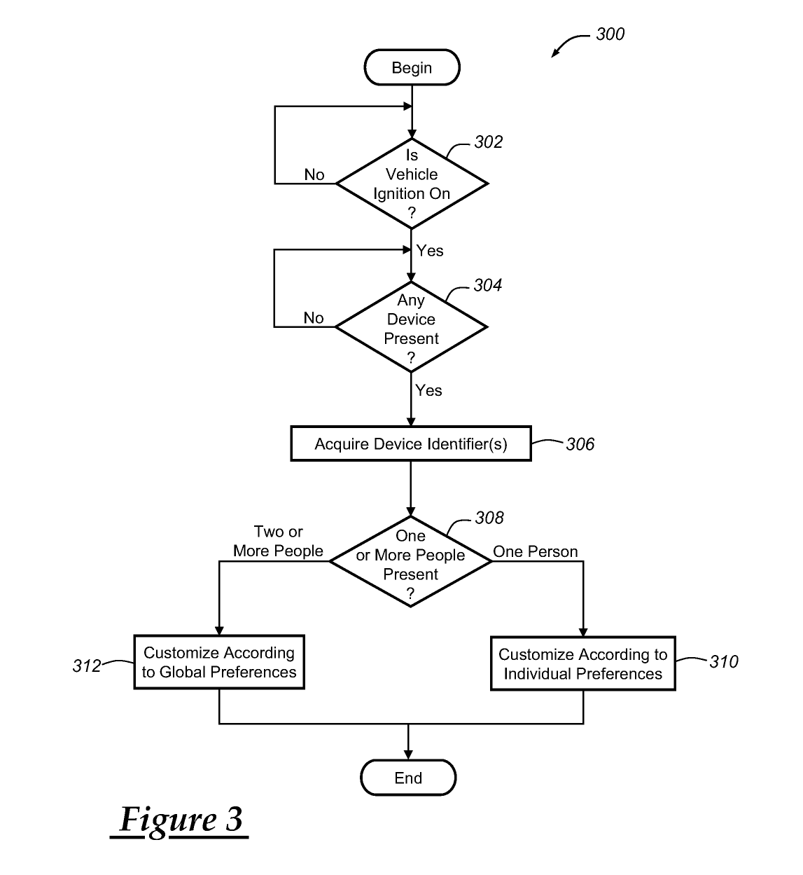

Turning now to FIG. 3, where a usage or operation method 300 will be described. The portions of this method in common with or similar to that of FIG. 2 can be carried out as described above. Beginning with step 302, method 300 determines if the vehicle ignition is on. Being ‘on’, in the context of this step, can mean many different things but preferably involves transitioning from an ‘off’ state to an ‘on’ state. It may optionally involves checking for the vehicle doors being closed, reaching a certain speed, etc. Therefore, a ‘vehicle-on’ is monitored to initiate determining if any mobile devices associated with their corresponding occupants are present in the vehicle. In one example, method 300 may determine if a ‘vehicle-on’ event has occurred where the operator has turned or otherwise engaged a key or other ignition device so that vehicle engine and/or motor are turned on after being off. In such an embodiment, processing device 52 may receive a signal from VSM 42 (e.g., an ignition module or some other component, device, module, etc.) indicating that a key-on situation has occurred. In another embodiment, processing device 52 may receive a signal from VSM 42 (e.g., battery) indicating that VSM 42 is powering vehicle 12 after a rest. These are, of course, only some of the potential ways in which step 302 may determine if the vehicle ignition is ‘on’, as any other technique known in the art may be used as well. If the vehicle ignition is not ‘on’, then the method loops back to step 302 for continued monitoring; if the vehicle ignition is ‘on’, then the method may continue on to step 304.

According to a particular embodiment, method 300 performs one or more of the following steps once the vehicle has been ‘on’ for a relatively short turn-on period (e.g., 30 seconds—15 minutes). A unique feature of the turn-on period is that, it is long enough so that one or more mobile devices are detected, but is short enough so that the method provides the subscriber with customized preferences in a short amount of time. Turn-on periods that are longer or shorter than the exemplary one provided above may also be used. Skilled artisan should appreciate that this technique and other techniques known in the art can be also employed.

At step 304, method 300 checks if there is any device present. The purpose of this step is to identify one or more mobile devices that can be associated with one or more occupants inside the vehicle. This step is similar to step 202 of method 200; and it can be carried out as described above. Once one or more devices are detected, method 300 proceeds next to step 306. However, in case no device is identified then method 300 stays at this step to keep checking if there is any device present. Similarly step 306, which acquires a device identifier is similar to step 204 of method 200; therefore, it can be carried out as described above.

Next, the method determines if one or more people are present in the vehicle (step 308). Once one or more identifiers are acquired per step 306, then, in one embodiment, processing device 52 can compare them to previously stored identifiers in memory 54 to identify one or more corresponding owners via previously made associations. Depending on the number of individual associations, processing 52 determines if only one or if more people are present in the vehicle. In a second embodiment, call center 20 may retrieve previously stored identifiers in database 84, for example, and compare them to recently acquired one or more identifiers. Later, call center 20 determines if only one or if more people are present in the vehicle via previously made associations. Other embodiments are possible, for example, vehicle 12 can store previously acquired data (e.g., identifiers, associations, etc.), and call center 20 may determine a total number of occupants or vice versa. Depending on the individual number of associations, method 300 determines if one occupant is present and proceeds to step 310 to customize vehicle 12 according to individual preferences; however, if two or more occupants are present then method 300 proceeds to step 312 to customize vehicle 12 according to global preferences. Method 300 can consider recently detected identifiers that are not previously associated with corresponding owners as friends and decide to either ignore them or proceed to step step 312. In addition, it may inform the subscriber about the new found devices immediately via telematics unit 30 if available (e.g., one or more devices associated with subscriber are present) or later if the subscriber is not present.

The customization according to individual preferences (step 310) or according to global preferences (step 312) may be applied in the same or different manner. In one embodiment, a command or a series of commands are sent by call center 20 and received by vehicle 12 telematics unit 30 to customize vehicle 12 according to subscriber preferences. The command may trigger a preference code stored in vehicle 12 memory 54 to enable a subscriber preference setting (e.g., code 1: seat position, code 2: preferred radio station, code 3: preferred vehicle cabin temperature, etc.) via processing device 52 which will communicate the preference command via a signal to the corresponding VSM 42 unit. However, in another embodiment, call center 20 can send an entire preference command versus a code to telematics unit 30 via a signal to the corresponding VSM 42 unit. In another yet embodiment, one or more preference commands are stored and processed inside vehicle 12 without any involvement from call center 20. Method 300 may optionally notify one or more vehicle occupants that one or more custom preferences are being applied. In one embodiment, vehicle 12 notifies one or more occupants via an audio system 36, a visual display 38, and/or others that one or more custom preferences are being applied. Then, the occupant can optionally accept or override the preferences. Skilled artisans will appreciate that other techniques are also possible.

It is to be understood that the foregoing description is not a definition of the invention, but is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

1. A method of providing a customized in-vehicle service to one or more people inside a vehicle via a vehicle telematics unit, comprising the steps of:
(a) detecting the presence of a personal mobile device at the vehicle;
(b) associating the detected mobile device with a specific person; and
(c) providing a customized service to the specific person identified via the vehicle telematics unit.

2. The method of claim 1, wherein step (b) further comprises associating the detected mobile device with the specific person using at least one identifier obtained wirelessly from the detected mobile device.

3. The method of claim 1, further comprising the step of generating a database containing the at least one identifier prior to step (a).

4. The method of claim 3, wherein the generating step comprises generating the database during initial telematics service subscriber setup.

5. The method of claim 3, wherein the generating step comprises generating the database in response to a telematics service subscriber entering the identifier either into a service website via a processing device or through the vehicle telematics unit.

6. The method of claim 5, wherein the processing device is a personal computer.

7. The method of claim 3, wherein the generating step comprises generating the database in response to the telematics unit detecting one or more identifiers, communicating at least one identifier to a service subscriber via a service website or through the telematics unit, and the service subscriber selecting one or more identifiers and associating them with one or more specific people.

8. The method of claim 3, wherein the database comprises at least a cellular phone number and/or a Bluetooth address of one or more personal mobile devices linked to one or more people associated with a telematics service subscriber.

9. The method of claim 3, wherein the generating step comprises storing the database at a call center.

10. The method of claim 9, wherein the database is updated at least once a year by the call center.

11. The method of claim 3, wherein the generating step comprises storing the database inside the vehicle and updating the database on a regular basis.

12. The method of claim 1, wherein the mobile device is a cellular device comprising either a mobile phone or a personal digital assistant (PDA).

13. The method of claim 1, wherein step (a) further comprises detecting the presence of a personal mobile device in the vehicle using a Bluetooth connection.

14. The method of claim 1, wherein one person can be associated with one or more mobile devices.

15. The method of claim 1, wherein step (c) further comprises setting global preferences if at least one other personal mobile device is detected at the vehicle that is associated with someone other than the specific person and otherwise setting individual preferences for the specific person.

16. The method of claim 15, wherein the preferences are set according to a priority list of people associated with the telematics service subscriber established either during initial telematics service subscriber setup or entered later either into the service website via a processing device or through the vehicle telematics unit by the telematics service subscriber.

17. The method of claim 15, wherein the preferences comprise restricting strong language radio programs if at least one of the detected mobile devices is associated with an occupant who is under a certain age.

18. The method of claim 15, wherein the preferences comprise limiting the speed of the vehicle if at least one of the detected mobile devices is associated with an occupant who is under a certain age.

19. The method of claim 15, wherein the preferences comprise informing emergency personnel in the event of an emergency via the telematics unit of the presence of one or more personal mobile devices associated with one or more occupants inside the vehicle.

20. A method of providing a customized in-vehicle service to one or more people inside a vehicle via a vehicle telematics unit, comprising the steps of:
(a) receiving a Bluetooth address associated with a personal mobile device;
(b) establishing a service preference based on a telematics service subscriber request entered via a service web application or the vehicle telematics unit;
(c) associating the service preference with the Bluetooth address;
(d) detecting the presence of the personal mobile device at the vehicle through a wireless connection between the mobile device and the vehicle;
(e) associating the detected mobile device with the service preference; and
(f) providing a customized service to one or more occupants in the vehicle using the service preference.
